(19) United States
(12) Patent Application Publication
(10) Pub. No.: US 2020/0294285 A1
(43) Pub. Date: Sep. 17, 2020

(54) RECONSTRUCTING IMAGES FOR A WHOLE BODY POSITRON EMISSION TOMOGRAPY (PET) SCAN WITH OVERLAP AND VARYING EXPOSURE TIME FOR INDIVIDUAL BED POSITIONS

(71) Applicant: KONINKLIJKE PHILIPS N.V., EINDHOVEN (NL)

(72) Inventors: Xiyun SONG, CUPERTINO, CA (US); Andriy ANDREYEV, WILLOUGHBY HILLS, OH (US); Chuanyong BAI, SOLON, OH (US); Jinghan YE, LIVERMORE, CA (US); Chi-Hua TUNG, AURORA, OH (US); Bin ZHANG, CLEVELAND, OH (US); Xiangyu WU, HUDSON, OH (US); Changhong DAI, WILLOUGHBY HILLS, OH (US); Tianrui GUO, RICHMOND HEIGHTS, OH (US); Zhiqiang HU, TWINSBURG, OH (US)

(21) Appl. No.: 16/758,005

(22) PCT Filed: Oct. 19, 2018
(86) PCT No.: PCT/EP2018/078663

§ 371 Date: Apr. 21, 2020

Related U.S. Application Data
(60) Provisional application No. 62/575,559, filed on Oct. 23, 2017.

(51) Int. Cl. G06T 11/00; G06T 5/50; G01T 1/29

(52) U.S. Cl. CPC G06T 11/008; G06T 5/50; G06T 2207/10104; G01T 1/2985; G06T 2207/20212; G06T 11/006

(57) ABSTRACT

A non-transitory computer-readable medium stores instructions readable and executable by a workstation (18) including at least one electronic processor (20) to perform an image reconstruction method (100). The method includes: operating a positron emission tomography (PET) imaging device (12) to acquire imaging data on a frame by frame basis for frames along an axial direction with neighboring frames overlapping along the axial direction wherein the frames include a frame (k), a preceding frame (k−1) overlapping the frame (k), and a succeeding frame (k+1) overlapping the frame (k); reconstructing an image of the frame (k) using imaging data from the frame (k), the preceding frame (k−1), and the succeeding frame (k+1).

### FIELD

The following relates generally to the medical imaging arts, medical image interpretation arts, image reconstruction arts, and related arts.

### BACKGROUND

A whole body scan is one of the most popular hybrid Positron emission tomography/computed tomography (PET/CT) procedures in clinical applications to detect and monitor tumors. Due to a limited axial field of view (FOV) of the PET scanner, a typical whole body scan involves acquisitions at multiple bed positions to cover and scan a patient body's from head to feet (or from feet to head). In other words, the whole body scan is done in a stepwise fashion: for each frame the patient bed is held stationary and the corresponding data in an axial FOV is acquired; then the patient is moved in the axial direction over some distance followed by acquisition of the next frame which encompasses a FOV of the same axial extent but shifted along the axial direction (in the frame of reference of the patient) by the distance over which the patient bed was moved; and this step and frame acquisition sequence is repeated until the entire axial FOV (again in the frame of reference of the patient) is acquired. It should also be noted that the term “whole body” scan does not necessarily connote that the entire body from head to feet is acquired—rather, for example, depending upon the clinical purpose the “whole body” scan may omit (for example) the feet and lower legs, or may be limited to a torso region or so forth.

Because the sensitivity of a typical PET scanner decreases linearly from center of FOV to an edge along an axial direction (in the frame of reference of the PET scanner), the statistics of counts in the edge region are much lower than in the central region. To compensate for this variation of sensitivity in the axial direction, typical whole body protocols provide an overlap between consecutive bed positions. That is, the FOV of two consecutive frames (i.e. bed positions) overlap in the frame of reference of the patient. The overlap could be up to 50% of the axial FOV.

For simplicity, an acquisition time for the scan is set to be the same for all bed positions (i.e. frames) in most studies. However, because the activity distributions and regions of interest vary by patient, it can be more beneficial to spend more time in some bed positions for better quality while spending less time in other bed positions that are of less interest. Thus, varying acquisition time for different frames has advantages.

List mode data from the scan needs to be reconstructed into volume images of radiopharmaceutical distributions in the body for doctors' review. In a typical approach, the PET imaging data acquired at each bed position is reconstructed independently of data acquired at other bed positions, thereby producing “frame images” that are then knitted together in the image domain to form the whole-body PET image. For example, considering a 3-bed-position study with iterative Ordered Subset Expectation Maximization (OSEM) reconstruction, an update of a k-th bed position depends on the list mode events recorded for the k-th bed position only, according to Equation 1:

$${f}_{k}^{n + 1} = {f}_{k}^{n} \cdot \frac{{U}_{k}^{n}}{{S}_{k}} \qquad ( Equation 1 )$$

where fₖⁿ is the image to be updated, Uₖⁿ is the update matrix back-projected from the k-th bed list mode events, Sₖ is the sensitivity matrix calculated based on k-th bed position only and n is an iteration index. This way, reconstruction of the imaging data acquired for each frame (i.e. bed position) can be started as soon as acquisition of the imaging data for that frame is done and the complete data set for that frame is available. In fact, reconstructions of earlier bed positions and acquisitions of later bed positions are often going on concurrently. This makes the results be available as soon as possible. Once the reconstructed images of all bed positions are completed, the images are knitted together to generate the whole body image.

The following discloses new and improved systems and methods to overcome these problems.

### SUMMARY

In one disclosed aspect, a non-transitory computer-readable medium stores instructions readable and executable by a workstation including at least one electronic processor to perform an image reconstruction method. The method includes: operating a positron emission tomography (PET) imaging device to acquire imaging data on a frame by frame basis for frames along an axial direction with neighboring frames overlapping along the axial direction wherein the frames include a frame (k), a preceding frame (k−1) overlapping the frame (k), and a succeeding frame (k+1) overlapping the frame (k); reconstructing an image of the frame (k) using imaging data from the frame (k), the preceding frame (k−1), and the succeeding frame (k+1).

In another disclosed aspect, an imaging system includes a positron emission tomography (PET) imaging device; and at least one electronic processor programmed to: operate the PET imaging device to acquire imaging data on a frame by frame basis for frames along an axial direction with neighboring frames overlapping along the axial direction wherein the frames include a frame (k), a preceding frame (k−1) overlapping the frame (k), and a succeeding frame (k+1) overlapping the frame (k); reconstructing an image of the frame (k) using imaging data from the frame (k), the preceding frame (k−1), and the succeeding frame (k+1). The reconstruction of the image of the frame (k) is performed during acquisition of imaging data for a second succeeding frame (k+2) which succeeds the succeeding frame (k+1).

In another disclosed aspect, a non-transitory computer-readable medium stores instructions readable and executable by a workstation including at least one electronic processor to perform an image reconstruction method. The method includes: operating a positron emission tomography (PET) imaging device to acquire imaging data on a frame by frame basis for frames along an axial direction with neighboring frames overlapping along the axial direction wherein the frames include a frame (k), a preceding frame (k−1) overlapping the frame (k), and a succeeding frame (k+1) overlapping the frame (k); and reconstructing an image of the frame (k) using imaging data for lines of response intersecting areas defined by an overlap between the frame (k) and the preceding frame (k−1) and an overlap between the frame (k) and the succeeding frame (k+1). The reconstruction of the image of the frame (k) is performed during acquisition of imaging data for a second succeeding frame (k+2) which succeeds the succeeding frame (k+1).

One advantage resides in providing reconstructed images with a uniform sensitivity along an axial direction of each bed position in overlapping positions

Another advantage resides in reconstructing images while acquisition of further frames is ongoing, thereby allowing doctors to begin image review more quickly.

Another advantage resides in the reconstruction of any bed positions is independent of other bed positions, thereby allowing concurrent reconstruction during scan.

Another advantage resides in providing reconstructed images which reduce data storage, thereby conserving memory capacity.

Another advantage resides providing reconstructed images with improved count statistics for individual bed positions by directly using the events from neighboring bed positions.

Another advantage resides in providing reconstructed images with reduced small values in the sensitivity matrix, thereby reducing hot spot noise in edge slices.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The disclosure may take form in various components and arrangements of components, and in various steps and arrangements of steps. The drawings are only for purposes of illustrating the preferred embodiments and are not to be construed as limiting the disclosure.

FIG. 1 diagrammatically shows image reconstruction system according to one aspect.

FIG. 2 shows an exemplary flow chart operation of the system of FIG. 1;

FIG. 3 illustratively shows an example operation of the system of FIG. 1;

FIG. 4 illustratively shows another example operation of the system of FIG. 1.

### DETAILED DESCRIPTION

A disadvantage of independent frame-by-frame reconstruction followed by knitting the frame images together in the image domain is that this approach can waste valid events that contribute to the overlapped region but acquired from neighbor bed positions (e.g., not from the current bed position being processed). This leads to non-uniformity sensitivity along axial direction of each bed position.

An alternative approach is to wait until the raw data from all frames is collected, then pool the data to create a single whole body list mode data set that is then reconstructed as a single long object. This approach has the advantage of most effectively utilizing all collected data, especially at the overlaps; however, it has the disadvantages of requiring substantial computing power to reconstruct the large whole body list mode data set, especially for 1 mm or other high spatial resolution reconstruction. Moreover, this complex reconstruction cannot be started until the list mode data for the last frame is collected, which can lead to delay of the images for doctors' review.

Another alternative approach is to perform a joint-update in iterative reconstruction as compared to the independent self-update for individual bed positions. In this method, iterative reconstructions of all bed positions are launched concurrently, during which the forward projection and back-projection are performed for individual bed positions independently. However, all processes are synchronized and need to wait for all processes to reach the point of update operation. The update of any voxel in the region overlapped with the (k−1)-th bed position is the average of the update values from both k-th bed position reconstruction (itself) and the (k−1)-th bed position reconstruction. Similarly, the update of any voxel in the region overlapped with the (k+1)-th bed position is the average of the update values from both i-th bed position reconstruction (itself) and the (k+1)-th bed position reconstruction. Using the k=2 bed position as an example, according to Equation 2:

$${f}_{2}^{n + 1} = {f}_{2}^{n} \cdot ( \frac{{U}_{1}^{n}}{{S}_{1}} + \frac{{U}_{2}^{n}}{{S}_{2}} + \frac{{U}_{3}^{n}}{{S}_{3}} ) \qquad ( Equation 2 )$$

where additional

$$\frac{{U}_{1}^{n}}{{S}_{1}} and \frac{{U}_{3}^{n}}{{S}_{3}}$$

come from adjacent the first and the third bed position reconstructions, respectively; and n is iteration number. It is straightforward to see that update of any bed position depends on its leading or preceding neighbor bed position and its following or succeeding neighbor bed position. One disadvantage is of this method is that it requires concurrent reconstructions of all bed positions, which can lead to big burden on memory capacity. Another disadvantage is that it requires synchronization between reconstructions of all bed positions. This also leads to reconstruction time inefficiency if some bed positions have significantly more events than the rest bed positions. In addition, a concern can arise when using blob elements in the reconstruction about blobs in the very edge slices. For such blobs, their sensitivity value, S, could be extremely small because those blobs gave limited points of intersection with the lines of response (LORs) in the edge slices due to the limitation of the design of the blobs-voxel conversion. In that situation, the ratio

$$\frac{{U}_{2}^{n}}{{S}_{2}}$$

of those blobs can become abnormally large and unstable due to low counts in the edge slices so that the contribution from the neighbour bed positions

$$( e . g . \frac{{U}_{1}^{n}}{{S}_{1}} or \frac{{U}_{3}^{n}}{{S}_{3}} in reasonable and normal value range )$$

cannot help to control the abnormal value of

$$\frac{{U}_{2}^{n}}{{S}_{2}} .$$

As a result, it can lead to potential hot spots in the edge slices in individual bed positions due to noise.

In some existing PET imaging devices, each axial frame is reconstructed to form a corresponding frame image, and these frame images are merged (i.e. “knitted together”) in the image domain at the overlapping regions to form the whole body image. This approach is fast since the initially acquired frames can be reconstructed while list mode data for subsequent frames are acquired; but has disadvantages including producing non-uniform sensitivity in the overlap regions and failing to most effectively utilize the data acquired in the overlap regions.

Embodiments discloses herein overcome these disadvantages by employing a delayed frame-by-frame reconstruction, with each frame (k) being reconstructed using list mode data from that frame (k) and from the preceding frame (k−1) and the succeeding frame (k+1). In this reconstruction, the reconstructed image for prior frame (k−1) can be leveraged to more accurately estimate localization of electron-positron annihilation events along lines of response (LORs) that pass through frame (k−1). For the succeeding frame (k+1), a fast reconstruction can be employed for only the data of frame (k+1) to provide a similar localization estimate. It will be noted that with this approach the reconstruction of frame (k) begins after completion of the list mode data for succeeding frame (k+1). The use of list mode data from neighboring frames overcomes disadvantages of the frame-by-frame reconstruction approach, yet avoids the massive data complexity of the whole body list mode data set reconstruction approach and also allows for frame-by-frame reconstruction, albeit delayed by one frame due to the need to acquire frame (k+1) before starting reconstruction of frame (k).

In some embodiments, the final knitting of frame images in image space is also avoided. This is achievable since the contribution from neighboring frames is already accounted for by way of the sharing of data during per-frame reconstruction.

Another aspect is that the disclosed improvement facilitates use of different frame list mode acquisition times (i.e. different “exposure times”) for different frames. In the reconstruction, the different frame list mode acquisition times are accounted for by ratioing the acquisition times of the various frames when combining data from neighboring frames during the reconstruction.

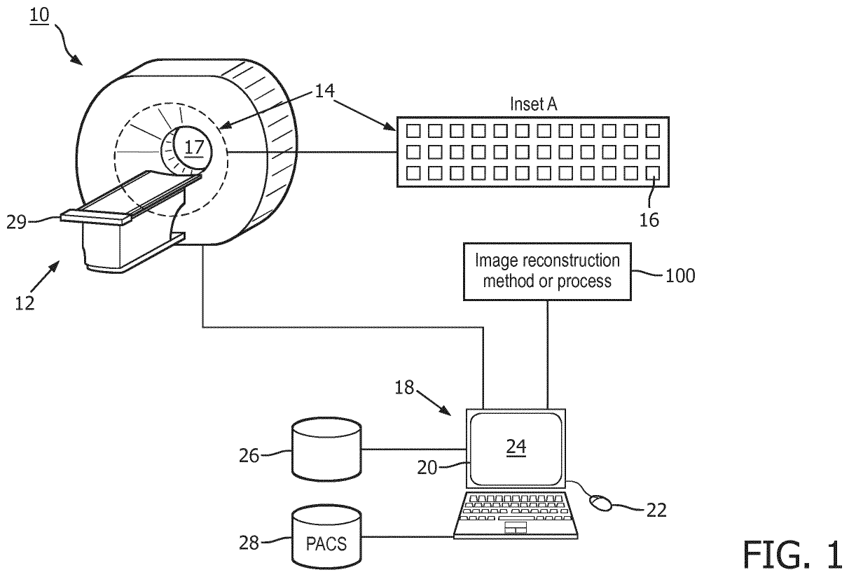

With reference to FIG. 1, an illustrative medical imaging system 10 is shown. As shown in FIG. 1, the system 10 includes an image acquisition device 12. In one example, the image acquisition device 12 can comprise an emission imaging device (e.g., a positron emission tomography (PET) device). The image acquisition device 12 includes a pixelated detector 14 having a plurality of detector pixels 16 (shown as Inset A in FIG. 1) arranged to collect imaging data from a patient disposed in an examination region 17. In some examples, the pixelated detector 14 can be a detector ring of a PET device (e.g., an entire PET detector ring or a portion thereof, such as a detector tile, a detector module, and so forth). Although not shown in FIG. 1, a combined or “hybrid” PET/CT image acquisition device that includes a PET gantry and a transmission computed tomography (CT) gantry is commonly available. An advantage of the PET/CT setup is that the CT imaging can be used to acquire an anatomical image from which a radiation attenuation map can be generated for use in compensating the PET imaging data for absorption of 511 keV gamma rays in the body of the patient being imaged. Such attenuation correction is well known in the art and accordingly is not further described herein.

The system 10 also includes a computer or workstation or other electronic data processing device 18 with typical components, such as at least one electronic processor 20, at least one user input device (e.g., a mouse, a keyboard, a trackball, and/or the like) 22, and a display device 24. In some embodiments, the display device 24 can be a separate component from the computer 18. The workstation 18 can also include one or more databases 26 (stored in a non-transitory storage medium such as RAM or ROM, a magnetic disk, or so forth), and/or the workstation can be in electronic communication with one or more databases 28 (e.g., an electronic medical record (EMR) database, a picture archiving and communication system (PACS) database, and the like). As described herein the database 28 is a PACS database.

The at least one electronic processor 20 is operatively connected with a non-transitory storage medium (not shown) that stores instructions which are readable and executable by the at least one electronic processor 20 to perform disclosed operations including performing an image reconstruction method or process 100. The non-transitory storage medium may, for example, comprise a hard disk drive, RAID, or other magnetic storage medium; a solid state drive, flash drive, electronically erasable read-only memory (EEROM) or other electronic memory; an optical disk or other optical storage; various combinations thereof; or so forth. In some examples, the image reconstruction method or process 100 may be performed by cloud processing.

To perform PET imaging, a radiopharmaceutical is administered to the patient to be imaged, and frame-by-frame acquisition is commenced after sufficient time has elapsed for the radiopharmaceutical to collect in an organ or tissue of interest. To achieve frame-by-frame imaging a patient support 29 is moved in a stepwise fashion. For each frame the patient bed 29 is held stationary and an axial FOV of the examination region 17 is acquired using the pixelated PET detector 14; then the patient is moved in the axial direction over some distance followed by acquisition of the next frame which encompasses a FOV of the same axial extent but shifted along the axial direction (in the frame of reference of the patient) by the distance over which the patient bed 29 was moved; and this step and frame acquisition sequence is repeated until the entire axial FOV (again in the frame of reference of the patient) is acquired.

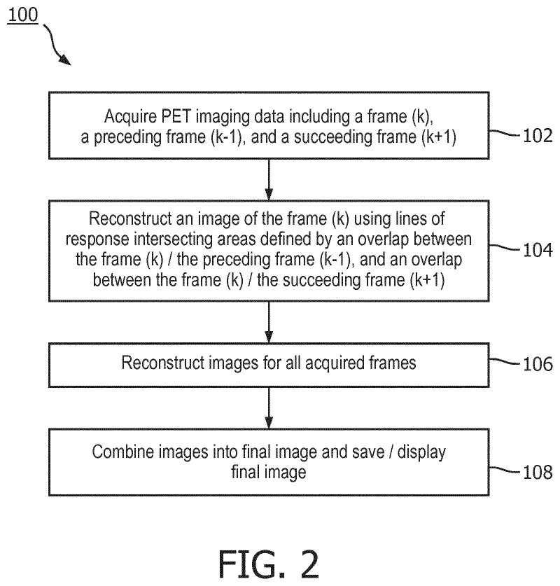

With reference to FIG. 2, an illustrative embodiment of the image reconstruction method 100 is diagrammatically shown as a flowchart. At 102, the at least one electronic processor 20 is programmed to operate the PET device 12 to acquire imaging data on a frame by frame basis for frames along an axial direction. Neighboring frames overlap along the axial direction. The frames include a “current” frame (k), a preceding frame (k−1) overlapping the frame (k), and a succeeding frame (k+1) overlapping the frame (k). The term “preceding frame (k−1)” refers to the frame acquired immediately prior in time to acquisition of the frame (k), and similarly “succeeding frame (k+1)” refers to the frame acquired immediately after acquisition of the frame (k) in time. The frames are acquired sequentially along the axial direction; for example, labelling (without loss of generality) the axial direction as running from left to right, the preceding frame (k−1), frame (k), and succeeding frame (k+1) are acquired in that time sequence, with the preceding frame (k−1) being the leftmost of the three frames, frame (k) being the middle frame, and succeeding frame (k+1) being the rightmost frame. Of course, the acquisition could be in the opposite direction, i.e. running right to left in which case preceding frame (k−1) would be the rightmost of the three frames, frame (k) would again be the middle frame, and succeeding frame (k+1) would be the leftmost frame. Similarly, instead of the orientation labels “left” and “right” one could substitute other appropriate labels such as “toward the head” and “toward the feet”).

In some examples, the imaging data can be acquired as list mode data. For example, the imaging data can have frame acquisition times for the frame (k), the preceding frame (k−1), and the succeeding frame (k+1) which are not all the same. The PET imaging device 12 is operated by the at least one electronic processor 20 to acquire imaging data on a frame by frame basis with neighboring frames overlapping, for example in some embodiments with at least 35% overlap along the axial direction although smaller overlap is contemplated depending upon the sensitivity falloff near the edges of the FOV, to acquire imaging data for the frame (k), the preceding frame (k−1), and the succeeding frame (k+1). Again, the order of acquisition is: preceding frame (k−1) followed by frame (k) followed by frame (k+1). It is to be understood that each frame (excepting the first and last frames) can be viewed as a “frame (k)” having a preceding frame (k−1) and a succeeding frame (k+1). In some examples, the lack of a preceding frame for the first frame, and similar lack of a succeeding frame for the last frame, can be variously dealt with. In a straightforward approach, the first frame is not included as a frame in the final whole-body image, but merely is acquired to serve as the preceding frame for the second frame; and likewise the last frame is not included as a frame in the final whole-body image, but merely is acquired to serve as the succeeding frame for the second-to-last frame; so that the whole body image corresponds to the second through second-to-last frames. In other examples, existing methods, or one of the preceding or succeeding frames can be used to compensate for the lack of a preceding or succeeding frame, as described in more detail below.

At 104, the at least one electronic processor 20 is programmed to reconstruct an image of the frame (k) using imaging data from the frame (k), the preceding frame (k−1), and/or the succeeding frame (k+1). In some embodiments, the frame (k) is reconstructed using imaging data for lines of response intersecting an area defined by an overlap between the frame (k) and the preceding frame (k−1), and/or an overlap between the frame (k) and the succeeding frame (k+1). In most embodiments, the frame (k) is reconstructed using both of these overlapping areas.

The reconstruction of one of the image frames can occur during imaging data acquisition of a different image frame. For example, the reconstruction of the image of the frame (k) is performed during acquisition of imaging data for a second succeeding frame (k+2) which succeeds the succeeding frame (k+1). Advantageously, this simultaneous reconstruction/acquisition operation allows a medical professional to more quickly begin a review of the imaging data.

In some embodiments, the reconstruction can include reconstructing an image of the preceding frame (k−1) during acquisition of imaging data for the succeeding frame (k+1) using imaging data from the preceding frame (k−1), a second preceding frame (k−2) preceding the frame (k−1), and the frame (k). In this example, the reconstruction of the frame (k) includes using the image of the preceding frame (k−1) reconstructed using imaging data from the frames (k−2), (k−1), and (k) in estimating localization of electron-positron annihilation events along lines of response that intersect frame (k−1).

In other embodiments, the reconstruction can include using image estimates to expedite the reconstruction by providing a fast image estimate for succeeding frame (k+1) for use in reconstruction of frame (k). For example, during acquisition of imaging data for the second subsequent frame (k+2), the at least one processor 20 can be programmed to generate an image estimate for the frame (k+1) using only the imaging data for the frame (k+1). This image estimate for the frame (k+1) in can be used to estimate localization of electron-positron annihilation events along lines of response that intersect frame (k+1).

In further examples, the entirety of the current frame (k), the preceding frame (k−1), and the succeeding frame (k+1) can be used, rather than just the overlapping portions between the frames. The longer volume provided by the entirety of these frames allows for estimation of scatter contribution which can include out of field-of-view activities. In still further examples, data from a second preceding frame (k−2) and a second succeeding frame (k+2) can be used in the reconstruction of the current image frame (k).

In some examples, when the imaging data is acquired as PET list mode data, the reconstruction can include reconstructing the frame (k) using the list mode data from the frame (k), the preceding frame (k−1), and the succeeding frame (k+1). In other examples, when the PET imaging data includes different acquisition times for each of the frames, the reconstruction can include reconstructing the frame (k) using a ratio of frame acquisition times to compensate for the frame acquisition times for the frames (k−1), (k), and (k+1) not being all the same.

In other examples, each of the frames are reconstructed independently of the other frames. In some instances, the reconstruction can take substantial time to complete. To compensate for this, the “later” frames (e.g., the succeeding frames from the current frame (n)) can undergo a more powerful reconstruction than the “earlier” frames (e.g., the preceding frames from the current frame (n)) so that the reconstruction of all frames can finish at nearly the same time.

At 106, the at least one electronic processor 20 is programmed to repeat the process 102, 104 for each successively acquired frame. In other words, all frame acquired are reconstructed.

At 108, the at least one electronic processor 20 is programmed to combine the images for all frames acquired during the operating to generate a final image. In some examples the combining does not include knitting images for neighboring frames together in image space. The final image can be displayed on the display device 24 and/or saved in the PACS 28.

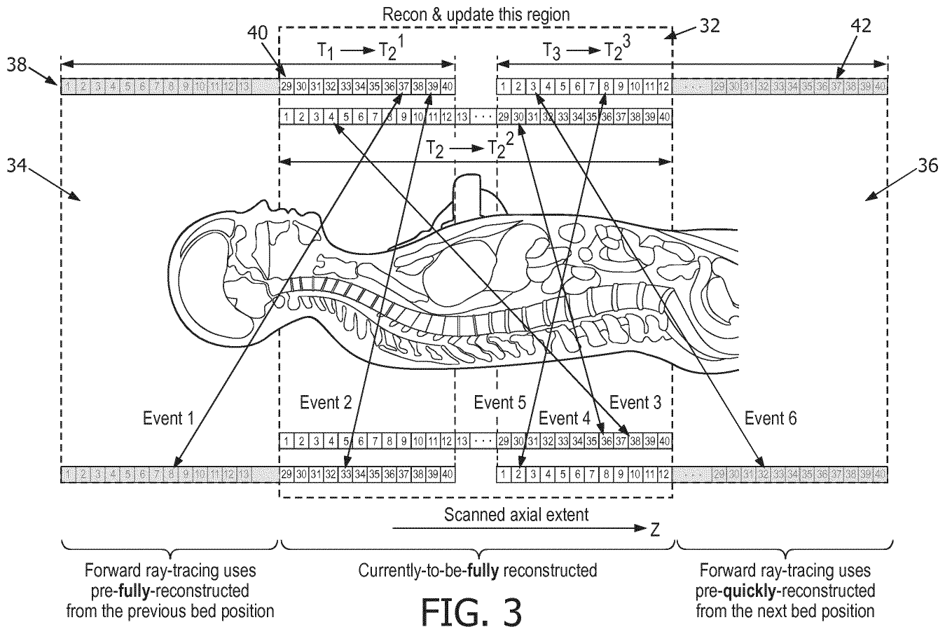

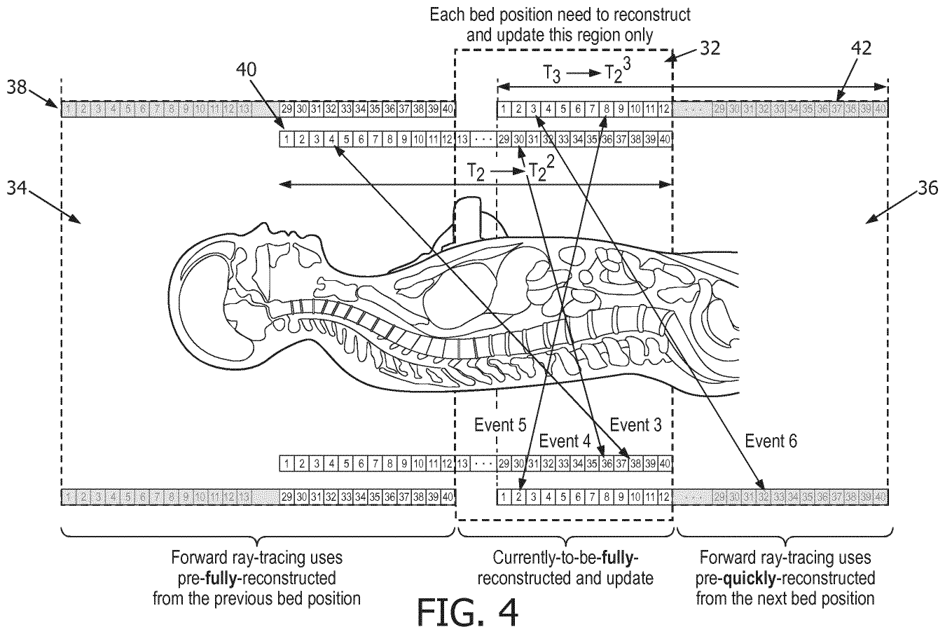

FIGS. 3 and 4 illustratively show examples of the acquiring and reconstruction operations 102 and 104. FIG. 3 depicts the current frame (k) 32, the preceding frame (k−1) 34, and the succeeding frame (k+1) 36. As shown in FIG. 3, annihilation events (depicted by the LOR arrows) can occur that are detected during the current frame 32 and one of the preceding frame 34 or the subsequent frame 36. Each of the frames 32, 34, 36 have a corresponding acquisition time T₁, T₂ and T₃. The detector pixels 16 can include a first detector array 38, a second detector array 40, and a third detector array 42. The first detector array 38 is positioned at a “left” overlap region and acquires list mode data P₂¹ for duration of T₁, such as Event 1 and Event 2 illustrated in FIG. 3. Similarly, the second detector array 40 is positioned “centrally” and acquires list mode data P₂² for duration of T₂, such as Event 3 and Event 4. The third detector array 42 is positioned at a “right” overlap region and acquires list mode data P₂³ for scan duration of T₃, such as Event 5 and Event 6 illustrated. The three list mode data sets are combined as P₂=P₂¹ ∪P₂²∪P₂³, representing the list mode data set for the current frame 32.

In some embodiments, the combined data set P₂ is used to reconstruct the image. A sensitivity matrix is calculated, along with a series of correction factors (e.g., attenuation, scatters, randoms, detector responses, and the like) for all events in the list mode dataset P₂. Forward and backward projections are performed for all events in the list mode dataset P₂ with normalization for the different acquisition times T₁, T₂ and T₃. In some examples, e.g., for the events at LORs that extend to adjacent bed positions, such as Event 1 and Event 6 illustrated in Error! Reference source not found., forward projection ray-tracing in the neighboring bed regions uses pre-reconstructed images. In particular, for Event 1, the preceding frame 34 represents an earlier bed position and has been previously fully-reconstructed, and thus is available. For Event 6 (or another subsequent event), the subsequent frame 36 represents a later adjacent bed position and has not been fully-reconstructed yet, but can be quickly-reconstructed using various conventional bed-by-bed methods. Such a “quick-reconstruction” does not need to be very high quality or fully converged, as long as it provides reasonable estimate of the activity in the subsequent frame 36 for forward ray-tracing. The impact of these subsequent events on the update of the current frame 32 is relatively small, especially for time of flight reconstruction. Images of both neighboring regions in the preceding frame 34 and the subsequent frame 36 are not updated, and thus there is no need to do ray-tracing in the preceding frame 34 and the subsequent frame 36 during back-projection. In other words, back-projection ray-tracing for Event 1 and Event 6 is performed for the current frame 32 only. The image frames can be updated with a back projection with the matched sensitivity index.

FIG. 4 shows another example of the acquiring and reconstruction operations 102 and 104. In some embodiments, it is unnecessary to reconstruct the overlapped region (i.e., the preceding frame 34) for a second time in the next bed position (i.e., the succeeding frame 36). In fact, each bed reconstruction only needs to reconstruct a partial region of the axial FOV instead of the whole axial FOV, as shown in Error! Reference source not found. For those events involving neighboring bed positions (such as Event 3 and Event 6 in Error! Reference source not found.), ray-tracing of forward-projection in the neighboring regions uses previously fully-reconstructed (k−1)-th bed position image and previously quickly-reconstructed (k+1)-th bed position image. Ray-tracing of back-projection is performed in the current k-th bed position region only, not in the neighboring bed position regions.

### Example

As briefly described previously, the disclosed embodiments use a “virtual scanner” to model the combined acquisitions from the main detector arrays and the overlap detector arrays with either the same or varying scan time T for individual bed positions, as shown in FIG. 3.

First, the list mode events are regrouped for each bed position, the next neighbor of which has finished its acquisition, so that the new list mode dataset Pₖ for the k-th bed position is expressed in Equation 3:

Pₖ=Pₖ^{k-1}∪Pₖ^{k}∪Pₖ^{k+1} (Equation 3)

where the subscript index k denotes the current bed position being processed; Pₖ^{k-1} represents those events in the left overlap acquired from the (k−1)-th bed position; Pₖ^{k+1} represents those events in the right acquired from the (k+1)-th bed position; and Pₖ^{k} represents those events acquired from k-th bed position itself.

For OSEM reconstruction as an example, the new list mode dataset Pₖ needs to be split into smaller subsets, P_{k,m} where the subscript index m denotes the m-th subset. Pₖ^{k-1}, Pₖ^{k} and Pₖ^{k+1} are split separately into P_{k,m}^{k-1}, P_{k,m}^{k} and P_{k,m}^{k+1} respectively, as shown in Equation 4:

P_{k,m}=P_{k,m}^{k-1}∪P_{k,m}^{k}∪P_{k,m}^{k+1}. (Equation 4)

The algorithm (e.g., a list mode OSEM) for the k-th bed position is expressed in Equation 5:

$$( Equation 5 )$$

$${f}_{k}^{m} [ i ] = {f}_{k}^{m - 1} [ i ] \{ ( 1 - λ ) + \frac{λ}{S [ i ]} ( \begin{matrix}\frac{{T}_{k - 1}}{{T}_{k}} {\sum }_{e ∈ {P}_{k , m}^{k - 1}} {B}_{{j}_{e} i}^{k - 1} \frac{1}{\begin{matrix}\frac{{T}_{k - 1}}{{T}_{k}} ( {\sum }_{v = 1}^{V} {H}_{{j}_{e} v}^{k - 1} {f}_{k}^{m - 1} [ v ] ) + \\ {\sum }_{u = 1}^{U} {H}_{{j}_{e} u}^{k - 1} {f}_{k - 1}^{const} [ u ] + \\ {SC}_{{j}_{e}}^{k - 1} + {RND}_{{j}_{e}}^{k - 1}\end{matrix}} + \\ {\sum }_{e ∈ {P}_{k , m}^{k}} {B}_{{j}_{e} i}^{k} \frac{1}{( {\sum }_{v = 1}^{V} {H}_{{j}_{e} v}^{k} {f}_{k}^{m - 1} [ v ] ) + {SC}_{{j}_{e}}^{k} + {RND}_{{j}_{e}}^{k}} + \\ \frac{{T}_{k + 1}}{{T}_{k}} {\sum }_{e ∈ {P}_{k , m}^{k + 1}} {B}_{{j}_{e} i}^{k + 1} \frac{1}{\begin{matrix}\frac{{T}_{k + 1}}{{T}_{k}} ( {\sum }_{v = 1}^{V} {H}_{{j}_{e} v}^{k + 1} {f}_{k}^{m - 1} [ v ] ) + \\ {\sum }_{w = 1}^{W} {H}_{{j}_{e} w}^{k + 1} {f}_{k + 1}^{const} [ w ] + \\ {SC}_{{j}_{e}}^{k + 1} + {RND}_{{j}_{e}}^{k + 1}\end{matrix}}\end{matrix} ) )$$

where S[i] is the sensitivity matrix for the new virtual system, given by Equation 6:

$$S [ i ] = \frac{{T}_{k - 1}}{{T}_{k}} {\sum }_{j ∈ all possible LOR for {P}_{k , m}^{k - 1}} {B}_{ji}^{k - 1} \cdot 1 + {\sum }_{j ∈ all possible LOR for {P}_{k , m}^{k}} {B}_{ji}^{k} \cdot 1 + \frac{{T}_{k + 1}}{{T}_{k}} {\sum }_{j ∈ all possible LOR for {P}_{k , m}^{k + 1}} {B}_{ji}^{k + 1} \cdot 1 \qquad ( Equation 6 )$$

In Equations 5 and 6, fₖ^{m}[i] is the value of the i-th out of a total of V elements in the estimated image for the k-th bed position from m-th subset. fₖ^{m-1}[i] is the previous estimate from the previous subset m−1. λ is a relaxation factor between 0 and 1 to control convergence and noise. Tₖ denotes acquisition time for k-th bed position. e denotes events and jₑ denote the LOR corresponding to the event e. Hⱼ_{ₑ}ᵢ^{k-1}, Hⱼ_{ₑ}ᵢ^{k} and Hⱼ_{ₑ}ᵢ^{k+1} are the system matrixes modeling data acquisition using detector arrays #1, #2 and #3 for the (k−1)-th, k-th and (k+1)-th bed positions (e.g., the forward projections), respectively. Similarly, Bⱼ_{ₑ}ᵢ^{k-1}, Bⱼ_{ₑ}ᵢ^{k} and B are the back-projections for the (k−1)-th, k-th and (k+1)-th bed positions, respectively. Various physics factors can be modeled in H, including attenuation and time of flight (TOF) for ray-tracing, detector geometry response, crystal efficiency, dead time loss, decay, etc. Scatter and randoms can be modelled separately, and so are not included in system matrix H. Similarly, Bⱼ_{ₑ}ᵢ^{k-1}, Bⱼ_{ₑ}ᵢ^{k} and Bⱼ_{ₑ}ᵢ^{k+1} are the back-projection for the (k−1)-th, k-th and (k+1)-th bed positions, respectively. (In practice, the back-projections do not need to be the exact transpose of the forward-projections. For example, it is acceptable to have point spread function (PSF) modeled in the forward-projection H, but not in the back-projection B. For another example, it is also acceptable to have a crystal efficiency modeled in forward-projection H, but not in back-projection B. The back-projections used in the calculation of sensitivity matrix and those in reconstruction should match each other. SCⱼ_{ₑ}^{k-1}, SCⱼ_{ₑ}^{k} and SCⱼ_{ₑ}^{k+1} represent the absolute quantity of scatters (and not just probability) that is expected to be detected at the bin of jₑ that matches the individual subsets P_{k,m}^{k-1}, P_{k,m}^{k} and P_{k,m}^{k+1}, respectively, not mixed. Similarly, RNDⱼ_{ₑ}^{k-1}, RNDⱼ_{ₑ}^{k} and RNDⱼ_{ₑ}^{k+1} represent the absolute quantity of randoms (and not just probability) that is expected to be detected at the bin of jₑ that matches the individual subsets P_{k,m}^{k-1}, P_{k,m}^{k} and P_{k,m}^{k+1}, respectively, not mixed. Various methods can be used to pre-calculate the scatters and randoms estimates. For example, Monte-Carlo-based single scatter simulation method can be used to estimate scatter, and a delayed window acquisition can be used to estimate the randoms.

Regarding those events involving neighboring bed positions (such as Event 1 and Event 6), note the corresponding components in Equation 5: Σᵤ₌₁^{U}Hⱼ_{ₑ}ᵤ^{k-1}fₖ₋₁^{const}[u] and Σ_{w=1}^{W}Hⱼ_{ₑ}_{w}^{k+1}fₖ₊₁^{const}[w], where the summation indexes v and w run over the corresponding regions with total voxel element quantities U and W in the adjacent frames k−1 and k+1 that have no intersection with the central frame k. The ray-tracing of forward-projection in the neighboring regions use the previously fully-reconstructed (k−1)-th bed position image referred to as fₖ₋₁^{const} and the previously quickly-reconstructed (k+1)-th bed position image fₖ₊₁^{const}. The ray-tracing of back-projection is performed in the current k-th bed position region only, not in the neighboring bed position regions. The quickly-reconstructed (k+1)-th bed position image fₖ₊₁^{const} only serves the purpose of supporting reconstruction of the k-th bed position. The final image of the (k+1)-th bed position comes from the full reconstruction of the (k+1)-th bed position.

Because a full-reconstruction of the k-th bed position requires previously quick-reconstructed (k+1)-th bed position image, the k-th bed full-reconstruction must wait until the (k+1)-th bed position data are available.

In calculation of the sensitivity matrix S[i], “j for all possible LOR” in the 3 summation terms means loop over all possible and valid LORs that can be formed by the detector arrays #1, #2 and #3 for the acquisition of dataset Pₖ^{k-1}, Pₖ^{k} and Pₖ^{k+1} respectively and separately.

Other iterative algorithms (e.g., Row Action Maximum Likelihood Algorithm) can be derived similarly following the basic idea of the virtual scanner in this disclosure. For example, the algorithms for the virtual scanner can be used to reconstruct the images. For example, the sensitivity matrix is calculated according to Equation 6. An initial estimate of the image (i.e., a uniform image) is selected and set. During a subset processing, for each subset data P_{k,m}^{k-1}, P_{k,m}^{k} and P_{k,m}^{k+1}, the following operations are separately: perform forward-projection for each event to estimate the trues component. Ray-tracing in the extended neighboring regions use pre-reconstructed activity distributions; normalize the trues projection by acquisition time,

$$\frac{{T}_{k - 1}}{{T}_{k}} , 1 and \frac{{T}_{k + 1}}{{T}_{k}} ,$$

respectively; add the corresponding scatters and randoms components to get the total projected events; take the ratio of 1 over the total projected events; and back-project the ratio only to the currently frame of the image. These values are summed from the P_{k,m}^{k-1}, P_{k,m}^{k} and P_{k,m}^{k+1} parts to get the summed back-projection image. The summed back-projection image is divided by the sensitivity matrix for normalization to get the update image. If λ equals 1, the previous estimate fₖ^{m-1} is multiplied by the update image to get the new estimate fₖ^{m}. If λ is less than 1, the new estimate is calculated based on the weight of λ. These operations are repeated for all M subsets and this forms one iteration. These operations are repeated for additional iterations until a stop criteria is met.

The above operations are for one bed position. This process is repeated for all bed positions to generate all images. The quantity of the output images are corresponding to individual acquisition time Tₖ. If Tₖ varies from bed to bed, then the output images need to be normalized based on Tₖ before knitting into a single whole body image.

Because the right overlapped region of the (k−1)-th bed position and the left overlapped region of the k-th bed position are actually the same region and share the same combined list mode events data, the output images in the overlapped region between reconstructions of two consecutive bed positions are theoretically the same or very similar. Therefore, it is unnecessary to reconstruct the overlapped region for a second time in the next bed position. In fact, each bed reconstruction only needs to reconstruct a partial region of the axial FOV instead of the whole axial FOV, as shown in Error! Reference source not found. In this case, the terms corresponding to k−1 in equations (5) and (6) are gone and the equations are expressed as Equations 7 and 8:

$$( Equation 7 )$$

$${f}_{k}^{m} [ i ] = {f}_{k}^{m - 1} [ i ] \{ ( 1 - λ ) + \frac{λ}{S [ i ]} ( \begin{matrix}{\sum }_{e ∈ {P}_{k , m}^{k}} {B}_{{j}_{e} i}^{k} \frac{1}{\begin{matrix}( {\sum }_{v = 1}^{V} {H}_{{j}_{e} v}^{k} {f}_{k}^{m - 1} [ v ] ) + \\ {SC}_{{j}_{e}}^{k} + {RND}_{{j}_{e}}^{k}\end{matrix}} + \\ \frac{{T}_{k + 1}}{{T}_{k}} {\sum }_{e ∈ {P}_{k , m}^{k + 1}} {B}_{{j}_{e} i}^{k + 1} \frac{1}{\begin{matrix}\frac{{T}_{k + 1}}{{T}_{k}} ( {\sum }_{v = 1}^{V} {H}_{{j}_{e} v}^{k + 1} {f}_{k}^{m - 1} [ v ] ) + \\ {\sum }_{w = 1}^{W} {H}_{{j}_{e} w}^{k + 1} {f}_{k + 1}^{const} [ w ] + \\ {SC}_{{j}_{e}}^{k + 1} + {RND}_{{j}_{e}}^{k + 1}\end{matrix}}\end{matrix} ) \}$$

$$( Equation 8 )$$

$$S [ i ] = {\sum }_{j ∈ all possible LOR for {P}_{k , m}^{k}} {B}_{ji}^{k} \cdot 1 + \frac{{T}_{k + 1}}{{T}_{k}} {\sum }_{j ∈ all possible LOR for {P}_{k , m}^{k + 1}} {B}_{ji}^{k + 1} \cdot 1$$

Again, for those events involving neighboring bed positions (such as Event 3 and Event 6 in Error! Reference source not found.), ray-tracing of forward-projection in the neighboring regions uses previously fully-reconstructed (k−1)-th bed position image and previously quickly-reconstructed (k+1)-th bed position image. Ray-tracing of back-projection is performed in the current k-th bed position region only, not in the neighboring bed position regions.

The disclosure has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. A non-transitory computer-readable medium storing instructions readable and executable by a workstation including at least one electronic processor to perform an image reconstruction method, the method comprising:
operating a positron emission tomography (PET) imaging device to acquire imaging data on a frame by frame basis for frames along an axial direction with neighboring frames overlapping along the axial direction wherein the frames include a frame (k), a preceding frame (k−1) overlapping the frame (k), and a succeeding frame (k+1) overlapping the frame (k); and
reconstructing an image of the frame (k) using imaging data from the frame (k), the preceding frame (k−1), and the succeeding frame (k+1).

2. The non-transitory computer-readable medium of claim 1, wherein the reconstruction of the image of the frame (k) is performed during acquisition of imaging data for a second succeeding frame (k+2) which succeeds the succeeding frame (k+1).

3. The non-transitory computer-readable medium of claim 1, wherein reconstructing the image of the frame (k) using imaging data from the frame (k), the preceding frame (k−1), and the succeeding frame (k+1) includes:
reconstructing the image of the frame (k) using imaging data for lines of response intersecting at least one area defined by an overlap between the frame (k) and the preceding frame (k−1) and an overlap between the frame (k) and the succeeding frame (k+1).

4. The non-transitory computer-readable medium of claim 3, wherein reconstructing the frame (k) using data from the frame (k), the preceding frame (k−1), and the succeeding frame (k+1) further includes:
reconstructing the image of the frame (k) using imaging data for lines of response intersecting areas defined by an overlap between the frame (k) and the preceding frame (k−1) and an overlap between the frame (k) and the succeeding frame (k+1).

5. The non-transitory computer-readable medium of claim 1, further including:
reconstructing an image of the preceding frame-(k−1) during acquisition of imaging data for the succeeding frame (k+1) using imaging data from the preceding frame (k−1), a second preceding frame (k−2) preceding the frame (k−1), and the frame (k).

6. The non-transitory computer-readable medium of claim 5, wherein reconstructing the image of the frame (k) using imaging data from the frame (k), the preceding frame (k−1), and the succeeding frame (k+1) includes:
using the image of the preceding frame (k−1) reconstructed using imaging data from the frames (k−2), (k−1), and (k) in estimating localization of electron-positron annihilation events along lines of response that intersect frame (k−1).

7. The non-transitory computer-readable medium of claim 5, wherein reconstructing the image of the frame (k) using imaging data from the frame (k), the preceding frame (k−1), and the succeeding frame (k+1) further includes:
during acquisition of imaging data for the frame (k+2), generating an image estimate for the frame (k+1) using only the imaging data for the frame (k+1); and
using the image estimate for the frame (k+1) in estimating localization of electron-positron annihilation events along lines of response that intersect frame (k+1).

8. The non-transitory computer-readable medium of claim 1, wherein the operating acquires the imaging data as list mode imaging data and reconstructing the frame (k) using data from the frame (k), the preceding frame (k−1), and the succeeding frame (k+1) further includes:
reconstructing the frame (k) using the list mode data from the frame (k), the preceding frame (k−1), and the succeeding frame (k+1).

9. The non-transitory computer-readable medium of claim 1, wherein:
the operating includes operating the PET imaging device to acquire the imaging data with frame acquisition times for the frames (k−1), (k), and (k+1) which are not all the same; and
reconstructing the frame (k) includes using a ratio of frame acquisition times to compensate for the frame acquisition times for the frames (k−1), (k), and (k+1) not being all the same.

10. The non-transitory computer-readable medium of claim 1, wherein the operating includes operating the PET imaging device to acquire imaging data on a frame by frame basis with neighboring frames overlapping with at least 35% overlap along the axial direction.

11. The non-transitory computer-readable medium of claim 10 wherein the method further includes:
reconstructing images for all frames acquired during the operating wherein the reconstructing includes reconstructing the image of the frame (k); and
combining the images for all frames acquired during the operating to generate a final image wherein the combining does not include knitting images for neighboring frames together in image space.

12. An imaging system, comprising:
a positron emission tomography (PET) imaging device; and
at least one electronic processor programmed to:
operate the PET imaging device to acquire imaging data on a frame by frame basis for frames along an axial direction with neighboring frames overlapping along the axial direction wherein the frames include a frame (k), a preceding frame (k−1) overlapping the frame (k), and a succeeding frame (k+1) overlapping the frame (k); and
reconstruct an image of the frame (k) using imaging data from the frame (k), the preceding frame (k−1), and the succeeding frame (k+1);
wherein the reconstruction of the image of the frame (k) is performed during acquisition of imaging data for a second succeeding frame (k+2) which succeeds the succeeding frame (k+1).

13. The imaging system of claim 12, wherein reconstructing the frame (k) using data from the frame (k), the preceding frame (k−1), and the succeeding frame (k+1) further includes:
reconstructing the image of the frame (k) using imaging data for lines of response intersecting areas defined by an overlap between the frame (k) and the preceding frame (k−1) and an overlap between the frame (k) and the succeeding frame (k+1).

14. The imaging system of claim 12, further including:
reconstructing an image of the preceding frame (k−1) during acquisition of imaging data for the succeeding frame (k+1) using imaging data from the preceding frame (k−1), a second preceding frame (k−2) preceding the frame (k−1), and the frame (k).

15. The imaging system of claim 14, wherein reconstructing the image of the frame (k) using imaging data from the frame (k), the preceding frame (k−1), and the succeeding frame (k+1) includes:
using the image of the preceding frame (k−1) reconstructed using imaging data from the frames (k−2), (k−1), and (k) in estimating localization of electron-positron annihilation events along lines of response that intersect frame (k−1).

16. The imaging system of claim 14, wherein reconstructing the image of the frame (k) using imaging data from the frame (k), the preceding frame (k−1), and the succeeding frame (k+1) further includes:
during acquisition of imaging data for the frame (k+2), generating an image estimate for the frame (k+1) using only the imaging data for the frame (k+1); and
using the image estimate for the frame (k+1) in estimating localization of electron-positron annihilation events along lines of response that intersect frame (k+1).

17. The imaging system of claim 12, wherein the operating acquires the imaging data as list mode imaging data and reconstructing the frame (k) using data from the frame (k), the preceding frame (k−1), and the succeeding frame (k+1) further includes:
reconstructing the frame (k) using the list mode data from the frame (k), the preceding frame (k−1), and the succeeding frame (k+1).

18. The imaging system of claim 12, wherein:
the operating includes operating the PET imaging device to acquire the imaging data with frame acquisition times for the frames (k−1), (k), and (k+1) which are not all the same; and
reconstructing the frame (k) includes using a ratio of frame acquisition times to compensate for the frame acquisition times for the frames (k−1), (k), and (k+1) not being all the same.

19. The imaging system of claim 12, wherein the method further includes:
reconstructing images for all frames acquired during the operating wherein the reconstructing includes reconstructing the image of the frame (k); and
combining the images for all frames acquired during the operating to generate a final image wherein the combining does not include knitting images for neighboring frames together in image space.

20. A non-transitory computer-readable medium storing instructions readable and executable by a workstation including at least one electronic processor (20) to perform an image reconstruction method, the method comprising:
operating a positron emission tomography (PET) imaging device to acquire imaging data on a frame by frame basis for frames along an axial direction with neighboring frames overlapping along the axial direction wherein the frames include a frame (k), a preceding frame (k−1) overlapping the frame (k), and a succeeding frame (k+1) overlapping the frame (k); and
reconstructing an image of the frame (k) using imaging data for lines of response intersecting areas defined by an overlap between the frame (k) and the preceding frame (k−1) and an overlap between the frame (k) and the succeeding frame (k+1);
wherein the reconstruction of the image of the frame (k) is performed during acquisition of imaging data for a second succeeding frame (k+2) which succeeds the succeeding frame (k+1).

21. The non-transitory computer-readable medium of claim 19, wherein the method further includes:
reconstructing images for all frames acquired during the operating wherein the reconstructing includes reconstructing the image of the frame (k); and
combining the images for all frames acquired during the operating to generate a final image wherein the combining does not include knitting images for neighboring frames together in image space.
